(19) United States
(12) Patent Application Publication
(10) Pub. No.: US 2008/0205625 A1
(43) Pub. Date: Aug. 28, 2008

(54) EXTENDING A STANDARDIZED PRESENCE DOCUMENT TO INCLUDE CONTACT CENTER SPECIFIC ELEMENTS

(75) Inventors: BAIJU D. MANDALIA, BOCA RATON, FL (US); VICTOR S. MOORE, LAKE CITY, FL (US); WENDI L. NUSBICKEL, BOCA RATON, FL (US)

Correspondence Address: PATENTS ON DEMAND, P.A., 4581 WESTON ROAD, SUITE 345, WESTON, FL, 33331, US

(73) Assignee: INTERNATIONAL BUSINESS MACHINES CORPORATION, ARMONK, NY (US)

(21) Appl. No.: 11/684,286

(22) Filed: Mar. 9, 2007

Related U.S. Application Data
(63) Continuation-in-part of application No. 11/680,304, filed on Feb. 28, 2007.
Application No. 11/680,304 is a continuation-in-part of application No. 11/680,839, filed on Mar. 1, 2007.

(51) Int. Cl. H04M 3/00

(52) U.S. Cl. 379/265.02

(57) ABSTRACT

The present invention extends XML based presence documents to include contact center specific information. The XML presence document can conform to the Common Profiles for Instant Messaging (CPIM) and Presence (CPP) specification. The extended presence documents can permit contact center information to be conveyed across CPP compliant protocol boundaries without modification, with attendant benefits for security and performance. The contact center elements can include, but are not limited to, an agent status, an expertise, an agent level, a utilization rate, an average call time duration, and/or an average number of calls per day. The contact center extensions can be an important component for enabling a presence server to function as a skills based routing component of a standards based contact center, which unlike conventional contact centers can be formed from non-proprietary components that communicate using standard protocols.

### CROSS-REFERENCE TO RELATED APPLICATIONS

This continuation-in-part application claims the benefit of U.S. patent application Ser. No. 11/680,304 filed 28 Feb. 2007. and U.S. patent application Ser. No. 11/680,839 filed 1 Mar. 2007, which are hereby incorporated by reference herein.

### BACKGROUND

1. Field of the Invention

The present invention relates to the field of contact center technologies and, more particularly, to extending a standardized presence document that a presence server uses for data exchanges to include contact center specific elements.

2. Description of the Related Art

A conventional presence server is a physical entity that centrally manages presence information for a set of users and devices to which other users and devices can subscribe. The presence server is provided presence information from a communication node, which can include a presentity (e.g., a user) that uses a presence user agent (PUA) (e.g., a computer, phone, or other communication device). A series of watchers can subscribe to the presence server. A subscription permits the watcher to receive presence information and updates relating to an associated one or more presentities. Typically, a one-to-one correspondence between watchers and presentities exists. Communications to and from the presence server are formatted in accordance with the Presence Information Data Formal (PIDF) and/or the Rich Presence information Data format (RPID), both of which are open standards of the Internet Engineering Task Force (IETF). Conventional PIDF and RPID formats do not have elements that are adapted for handling contact center specific information.

Traditionally, presence servers have not interacted with contact center systems. A typical contact center utilizes proprietary hardware, software, and communication protocols provided by contact center solution vendors. The various components provided by the vendors are incompatible with one another, which results in a situation where customers are locked into a particular solution and are unable to integrate technologies and/or improvements from competing vendors or independent third party developers. More specifically, conventional contact centers use proprietary databases and code to perform skills based routing functions that connect callers to appropriate and available contact center agents.

U.S. patent application Ser. No. 11/680,304 entitled “IMPLEMENTING A CONTACT CENTER USING OPEN STANDARDS AND NON-PROPRIETARY COMPONENTS” establishes a contact center architecture that is not proprietary and which is referred to as an open contact center. U.S. patent application Ser. No. 11/680,839 entitled “SKILLS BASED ROUTING IN A STANDARDS BASED CONTACT CENTER USING A PRESENCE SERVER AND EXPERTISE SPECIFIC WATCHERS” discloses a contact center system that uses a presence server for its skills based routing function. The instant application describes how the RPID standard can be enhanced with contact center specific information, which permits contact center agents to provide presence information using an extended RPID format to a presence server, which in turn provides presence information in extended RPID format to an open contact center.

### SUMMARY OF THE INVENTION

The present invention extends XML based presence documents to include contact center specific information. The XML presence document can conform to the Common Profiles for Instant Messaging (CPIM) and Presence (CPP) specification. The extended presence documents can permit contact center information to he conveyed across CPP compliant protocol boundaries without modification, with attendant benefits for security and performance. In one embodiment the presence document extensions can be extensions of me Presence Information Data Format (PIDF) and/or the Rich Presence Information Data format (RPID). The contact center elements can include, but are not limited to, an agent status, an expertise, an agent level, a utilization rate, an average call time duration, and/or an average number of calls per day. The contact center extensions can he an important component for enabling a presence server to function as a skills based routing component of a standards based contact center, which unlike conventional contact centers, can be formed from non-proprietary components that communicate using standard protocols.

The present invention can be implemented in accordance with numerous aspects consistent with the material presented herein. For example, the present solution can include a presence document having contact center elements. The contact center elements can he configured to permit a contact center to exchange presence information with a CPP compliant presence server. The presence server can be used to determine contact center agent availability, where one of the contact center elements is an expertise element. The expertise element can indicate a type of expertise of a contact center agent that is needed for handling customer requests. The presence document can he an Extensible Markup Language (XML) based document that conforms to an Internet Engineering Task Force (IETF) established standard.

Another aspect of the present invention can include a presence management system for a contact center. The system can include a presence server, a data store, and one or more watchers. The presence server can accept, manage, and distribute presence information. The presence information can be conveyed to and from the presence server utilizing XML based documents that conform to an IETF established standard, The XML based documents can be conveyed across CPP compliant protocol boundaries without modification. The XML based documents can each include contact center elements. The data store, which can be communicatively linked to the presence server, can store the presence information. The stored presence information can include presence information for multiple contact center agents. The watchers can subscribe to the presence information managed by the presence server.

Yet another aspect of the present invention can include a method for conveying presence information. In the method, a presence user agent (PUA) associated with a contact center agent can convey an XML based presence document to a presence server. A watcher can subscribe to the presence server. An XML based presence document can be conveyed to the watcher from the PUA. The watcher can extract contact center information from the XML based presence document. The watcher can send the extracted contact center information to a contact center. The contact center can perform at least one programmatic action responsive to receiving the extracted contact center information. Each of the XML based presence documents can conform to a CPP standard and can include contact center elements and related values. Cue of the contact center elements can be an expertise element, which indicates a type of expertise of a contact center agent that is needed for handling customer requests.

Use of a presentity spanning field in a presence document is not restricted to a contact center context. That is, the invention can be utilized in any context, where a unique field (e.g., a focus element) of the presence document can be associated with a watcher, such that a one-to-one correspondence between watchers and values of the focus element exists. Each watcher can watch all users having a particular value for the focus element.

It should be noted that various aspects of the invention can be implemented as a program for controlling computing equipment to implement the functions described herein, or a program for enabling computing equipment to perform processes corresponding to the steps disclosed herein. This program may he provided by storing the program in a magnetic disk, an optical disk, a semiconductor memory, any other recording medium, or can also be provided as a digitally encoded signal conveyed via a carrier wave. The described program can be a single program or can be implemented as multiple subprograms, each of which interact within a single computing device or interact in a distributed fashion across a network space.

The method detailed herein can also be a method performed at least in part by a service agent and/or a machine manipulated by a service agent in response to a service request.

### BRIEF DESCRIPTION OF THE DRAWINGS

There are shown in the drawings, embodiments which are presently preferred, it being understood, however, that the invention is not limited to the precise arrangements and instrumentalities shown.

FIG. 1 is a schematic diagram illustrating a presence server using a standards based presence document having contact center specific elements in accordance with an embodiment of the inventive arrangements disclosed herein.

FIG. 2 is a schematic diagram illustrating a system for a presence server that performs skills based routing for a contact center in accordance with an embodiment of the inventive arrangements disclosed herein.

FIG. 3 is a schematic diagram of a system for using a presence server and watchers linked to agent expertise to assign contact center agents in accordance with an embodiment of the inventive arrangements disclosed herein.

FIG. 4 is a schematic diagram of a standards based contact center from an agent perspective that is implemented using WEBSPHERE enabled components and associated tooling in accordance with an embodiment of the inventive arrangements disclosed herein.

### DETAILED DESCRIPTION OF THE INVENTION

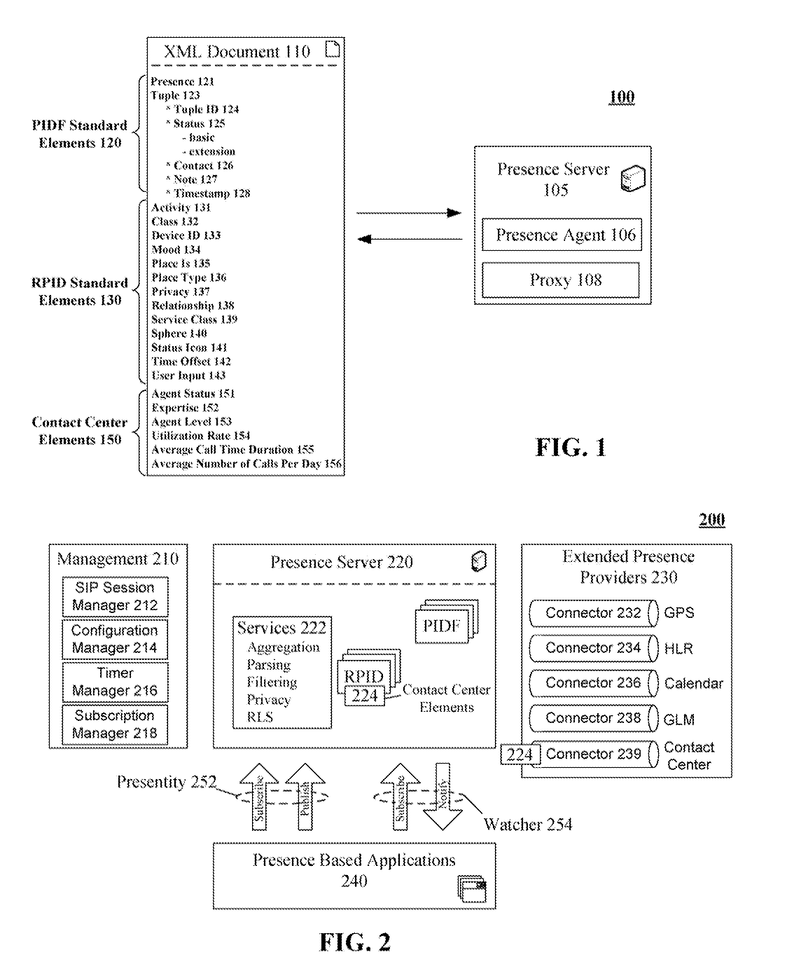

FIG. 1 is a schematic diagram illustrating a presence server 105 using a standards based presence document 110 having contact center specific elements in accordance with an embodiment of the inventive arrangements disclosed herein. The presence server 105 can be used for presence management functions of a contact center. That is, the presence server 105 can be standards based approach for performing skills based routing of callers to contact center agents. Communications to and from the presence server 105 can conform to open standards. For example, communications can be conducted using standards based presence documents 110, which can each be an Extensible Markup Language (XML) based document conforming to the Common Profiles for Instant Messaging (CPIM) and Presence (CPP) specification. Other open standards based specifications can also be used.

As defined herein, an open standard indicates that specifics of communication protocols, interfaces, and the like are published and available to third party vendors, who can construct solutions, enhancements, or extensions by conforming to the published standards. Open standards can include, but are not limited to, Presence Information Data Format (PIDF) based standards. Rich Presence Information Data format (RPID) based standards, XML based standards, service-oriented architecture (SOA) based standards. Real-time Transport Protocol (RIP) based standards, Media Resource Control Protocol (MRCP) based standards. Hyper Text Transfer Protocol (HTTP) based standards. Session Initiation Protocol (SIP) based standards, and the like. Open standards are often established by an independent standard setting body, such as the Internet Engineering Task Force (IETF), World Wide Web Consortium (W3C), etc., or by a cooperating consortium of multiple independent businesses, such as IBM, Sun Microsystems, and the like. Open standards, as used herein, can exist even though one or more companies maintains intellectual property rights to open contact center concepts, such as those presented in the instant application.

The presence server 105 can collect, manage, store, and distribute presence information regarding the access, availability, and willingness to communicate with other users. The presence server 105 can enable the extension of various telecommunication service provider applications and services to include collaboration information and how best to reach people. That is, the presence server 105 provides one or more presence services.

In one embodiment, the presence server 105 can be a stand-alone, carrier-grade, IP Multimedia Subsystem (IMS) compliant server. In another embodiment, a cluster of servers can be linked to create a single virtual presence server 105. Additionally, the presence server 105 can support PIDF and RPID. Communications with the presence server 105 can conform to IETF specifications for PUBLISH, SUBSCRIBE, and NOTIFY.

The presence server 105 can compose, translate, or filter a published presence state before delivering customized presence information to a watcher. For example, it can merge presence information from multiple presence user agents (PUAs), remove whole elements 120-156, translate values in elements 120-156, or remove information from elements 120-156.

In one arrangement, the presence server 105 can act as either a presence agent 106 or a proxy 108. When the presence server 105 acts as a presence agent 106, it can be aware of the presence information of a presentity through some protocol means, such as an IETF compliant means. When the presence server 105 acts as a proxy 108, it can send SUBSCRIBE requests to another entity that acts as a presence agent. Numerous commercial solutions can function as presence servers 105 including, but not limited to the WEBSPHERE presence server, CISCO unified presence server, ORACLE presence server, MICROSOFT OFFICE LIVE COMMUNICATION SERVER, and the like.

The XML document 110 can be used by a presentity to publish its presence status to the presence server 105. The XML document 110 can be used by the presence server 105 to notify some set of watchers. The XML document 110 can consist of a presence root element, zero or more tuples, zero or more note elements, and zero or more extension elements (e.g., elements 130-150) from other name spaces. Tuples can provide a way of segmenting presence information, such as segmenting information from distinct devices, segmenting information from different applications on the same device, or segmenting presence information that has been generated at different times.

The XML document 110 cart include PIDF standard elements 120, RPID standard elements 130, and contact center elements 150. PIDF (elements 120) and its extensions (elements 130 and 150) can be CPP compliant presence protocols that allow presence information to be transferred across CPP compliant protocol boundaries without modification, with attendant benefits for security and performance.

PIDF (elements 120) defines a basic format for representing presence information for a presentity. RPID (elements 130) can be an extension that adds optional elements to the PIDF. These RPID extensions provide additional information about a presentity and its contacts. The contact center elements 150 are a further extension to PIDF (elements 120), which can be implemented as an extension to RPID (elements 130). Contact center elements 150 add optional contact center specific elements, which permit the presence server 105 to perform skills based routing functions of a contact center. Elements 130 and 150 can both maintain compatibility with PIDF standards, so that PIDF-only watchers and gateways can continue to function properly when elements 130 and/or 150 are used.

PIDF standard elements 120 can include a presence element 121, zero or more tuples 123 elements, which can each include a tuple ID 124, a status 125, a contact 126, a note 127, and a timestamp 128.

The presence element 121 can include an entity attribute, which is the value of the Uniform Resource Locator (URL) of a presentity publishing XML document 110. The presence element contains a namespace declaration (‘xmlns’) to indicate the namespace on which the presence document 110 is based. The presence document 110 has the namespace ‘urn:ietf:params:xml:ns:pidf:’. Document 110 can contain other namespace declarations for the extensions used in the presence XML document 110.

The tuple 123 element provides a way of segmenting presence information. The tuple 123 element carries a presence tuple, which consists of a mandatory tuple ID element 124, a mandatory status 125 element, followed by any number of optional extension elements (possibly from other namespaces), followed by an optional contact 126 element, followed by any number of optional note 127 elements, followed by an optional timestamp 128 element.

The tuple ID 124 can be an arbitrary string used to distinguish this tuple from other tuples in the same presentity. The tuple ID 124 element can be used by applications processing the presence document 110 to identify the corresponding tuple in the previously acquired presence information of the same presentity. The value of the tuple ID 124 is a unique element for the same presentity.

The status 125 element contains one optional basic element, followed by any number of optional extension elements (possibly from other namespaces), under the restriction that at least one child element appears in the status 125 element. The basic element can be either open or closed and is used to indicate availability of the tuple 123 to receive communications. The optional extension elements allow different types of status values, such as reach-ability and location, to be represented by the tuple 123.

The contact 126 element can contain a URL of the contact address. It optionally has a priority attribute, whose value means a relative priority of this contact address over the others. Higher values indicate higher priority.

The note 127 element contains a string value, which is normally used for a human readable comment. The note 127 element can appear as a child element of presence 121 or as a child element of the tuple 123 element. In the former case the comment is about the presentity and in the latter case the comment is regarding the particular tuple 123.

The timestamp 128 element contains a string indicating the date and time of the status change of this tuple 123. The value of the timestamp 128 element can follow the Instant Messaging and Presence Protocol (IMPP) date time format. As a security measure, the timestamp 128 element should be included in all tuples 123 unless the exact time of a status change cannot be determined.

RPID elements 130 describe services, some devices, and/or some person. As such, they either extend <tuple>, <device>, or <person>, respectively. The activities 131 element can be a status element that enumerates what a person is doing. The class 132 can be an identifier that groups similar person elements, devices, or services. The device ID 133 in a tuple references a <device> element, which indicates that this <device> contributes to the service described by the tuple. Mood 134 can be a status element that indicates the mood of the person. Place is 135 can be a status element that reports on the properties of the place the presentity is currently at, such as the levels of light and noise. The place type 136 can be a status element that reports the type of place the person is located in, such as a classroom or home. The privacy element 137 distinguishes whether the communication service is likely to be observable by other parties. The relationship element 138 can indicate how a user relates to a person when a service reaches a user besides the person associated with the presentity.

The service class 139 describes whether the service is delivered electronically, is a postal or delivery service, or describes in-person communications. The sphere 140 characterizes the overall current role of the presentity. The status icon 141 depicts the current status of the person or service. The time offset 142 can be a status element that quantifies the time zone the person is in. The user input 143 can record user input or a usage state of a service or device based upon human user input.

Contact Center Elements 150 can include contact center specific fields. These fields can be used by a contact center that is communicatively linked to the presence server 105 in the performance of skills based routing, agent transfer, supervisor conferencing, and other functions. The contact center elements 150 can include an agent status 151, an expertise 152, an agent level 153, a utilization rate 154, an average call time duration 155, and/or an average number of calls per day 156.

The agent status 151 can represent a contact agent's availability to handle contact center calls. The agent status can include values of busy, available, on break, out of office, on vacation, and the like. The expertise 152 can be associated with a type of expertise or skill that is needed to handle contact center issues. In one embodiment, the expertise 152 can be code as unique numerical values (e.g., 1-10) each representing a particular expertise. Each contact center agent can have multiple areas of expertise 152. The agent level 153 can represent a degree of authority that a contact center agent possesses, which can have values such as apprentice, full agent, supervisor, and the like.

The utilization rate 154 can indicate how often an agent is used. In one configuration, it can be a measurement of agent efficiency (e.g., 90%). The average call time duration 155 can measure an average time required by a contact agent to handle a caller. Average call time duration 155 can be a measure of an agent's efficiency in quickly handling calls. The average number of calls per day 156 can indicate how many calls an agent is able to handle in a typical work period. Average calls per day 156 can be a measure of agent efficiency.

It should be appreciated that the elements 151-156 illustrate a few contemplated contact center specific elements, but that the invention is not limited to these elements alone and that other elements can be utilized. Different contact elements can be 151-156 added for many reasons, such as elements to track factors upon which contact center agents are paid. For example, agent bonuses can depend in part upon a caller satisfaction element (not shown). In another example, an expertise knowledge level (not shown) can indicate a relative strength of an agent in an associated expertise (e.g., basic, average, expert, and the like).

FIG. 2 is a schematic diagram illustrating a system 200 for a presence server 220 that performs skills based routing for a contact center in accordance with an embodiment of the inventive arrangements disclosed herein. System 200 can be one particular arrangement for the presence server 220 of system 100.

The presence server 220 can provide presence information to many different applications which include a contact center. The presence server 220 can provide numerous services 222 including aggregation, parsing, filtering, privacy, and resource list server (RLS) services. Software developers can write SIP servlets to add new services 222 or to modify behavior of existing services 222 as necessary.

Presence information used by the standards based presence server 220 can conform to a number of open standards defined by organizations such as the IETF. For instance, information can be stored in PIDF, RPID, and the like. RPID information can be extended to include contact center specific elements 224, such as elements 150 of system 100. RPID including contact center elements 224 can be designed so that much of the information can be derived automatically, such as from calendar files or user activity.

Management 210 functions can be performed by a SIP session manager 212, a configuration manager 214, a timer manager 216, and a subscription manager 218. The SIP session manger 212 can manage multiple simultaneous SIP based communication sessions, where sessions can include voice content, video content, chat content, interactive game content, Web content, virtual reality content, and the like.

The configuration manager 214 can permit an authorized user to configure parameters and details for communication sessions in which presence information is handled by the presence server 220. The timer manager 216 can manage a frequency through which presence information is updated from presentities 252 and a frequency through which watchers 254 are provided event package updates. The subscription manager 218 can handle subscriptions established between the presence server 220 and the watchers 254.

The presence server 220 can publish presence information, such as location, availability, capability, role, etc., to extended presence providers 230, that can serve Web pages and that provide Web services. A set of connectors 232-239 can link providers 230 to the presence server 220. For example, connector 232 can connect to a global positioning system (GPS) component; connector 234 can connect to a home location register (HLR) component; connector 236 can connect to a calendar component; connector 238 can connect to a Group and List Management (GLM) component: and, connector 239 can connect to a contact center. Communication with the contact center can involve the use of the contact center elements 224.

Presence based applications 240 executing on computing devices linked to the presence server 220 can use the publish/subscribe/notify capabilities of the presence server 230. For example, presentities 252 can publish information to the presence server and can also subscribe to receive presence information concerning other presentities 252. Watchers 254 can subscribe to presentities monitored by the presence server 220 and can receive notifications when changes occur related to the presentity to which the subscription relates.

Bach watcher 254 can be used to watch particular event packages of presence server 220. A watcher 254 can have a listener on an event package. That is, a listener can be used to inform the associated watcher 254 for a change and can convey a copy of a new event package which includes the changed information to the watcher 254 whenever a change is detected. Changes are published from presentities 252 using PDAs. The presence server 220 can iteratively cycle through subscriptions and can send event packages as necessary using the listener/watcher 254 design.

A series of rules can be established in the presence server 220 for each presentity 252 and watcher 254. For example, each watcher 254 can establish a watcher specific rule, such as to receive only a subset (e.g., filter) of an event package. In one embodiment, a one-to-one correspondence can exist between watchers 254 and presentities 252. In another embodiment specifically tailored for contact centers, each watcher 254 can be established to watch a particular expertise field, where an expertise corresponds to a contact center agent skill. For example, an expertise code of one (“expertise=1”) can indicate that an associated agent has expertise in product warranty. If ten agents are registered with the presence server 220 and a contact center has five categories of expertise, then five watchers 254 can be established, one for each category of expertise. Additionally, each of the ten agents can have multiple skills, which places that, agent on a list of agents maintained by multiple ones of the expertise-based watchers 254. Accordingly, each watcher 254 can watch all agents, but can listen to one particular item in an event package (e.g., an expertise field). Whenever a contact center needs an agent to handle a product warranty call, the watcher 254 associated with that expertise can be queried, which watches all agents having the product warranty skill.

Additionally, fitters can be applied to the watcher 254 to further refine a caller's needs. For example, different inquiries can require different levels of skills in a particular expertise field. Agent skill levels can be maintained by the presence server 220 and only those agents having a skill level that meets or exceeds the level needed for a caller request will be considered for agent transfer purposes. Different filters in the watcher 254 and/or the presence server 220 can be used to add any level of complexity to the routing of calls to agents. Accordingly, unlike conventional call center agent transfer capabilities which are implemented using proprietary toad balancing and transfer code and have limited configurable options, system 200 can be based upon flexible open standards that make it relatively easy to customize system 200 for business specific behavior and business specific circumstances.

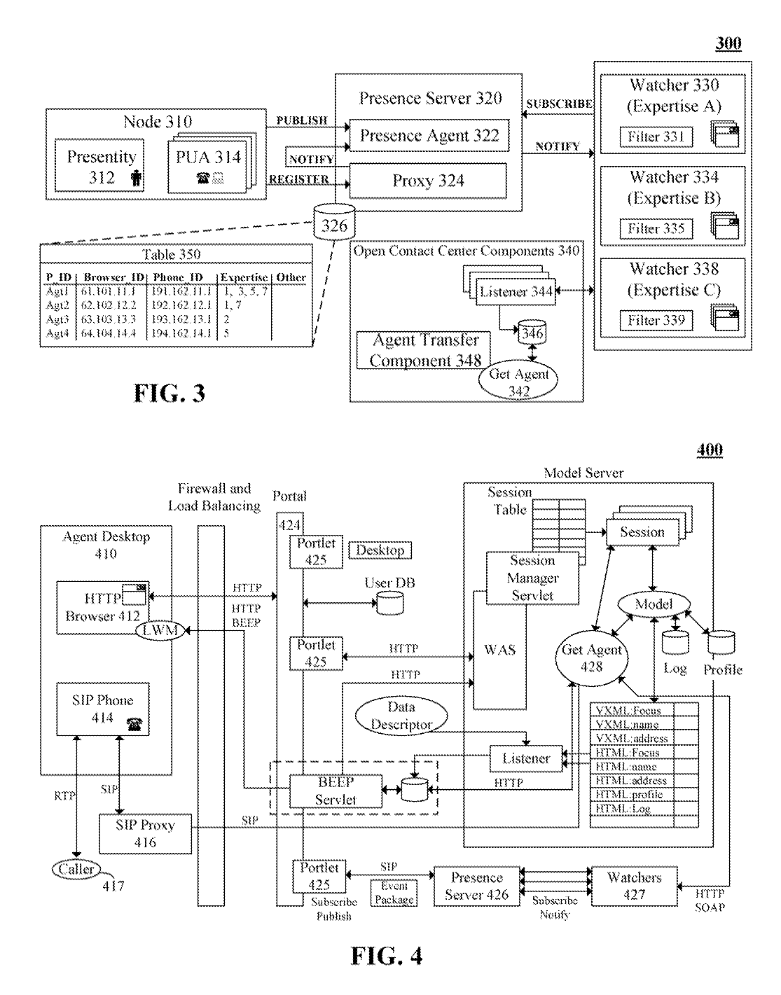

FIG. 3 is a schematic diagram of a system 300 for using a presence server and watchers linked to agent expertise to assign contact center agents in accordance with an embodiment of the inventive arrangements disclosed herein. Specifically, contact center functionality can be implemented using standardized components 340, which can be components adhering to one or more open standards. Communications to and from the presence server 320 can be conducted using XML presence documents having contact center specific extensions, as shown in system 100.

The open contact center can provide mechanisms for an agent desktop, agent authentication, agent monitoring, agent transfer, application integration, call queuing, collaboration integration, load balancing, reporting, skills based routing, supervisor conferencing, and the like. The skills based routing functions can utilize the presence server 320 and watchers 330, 334, and 338.

Each of the watchers 330, 334, and 338 can be associated with a particular expertise. Further, presence information maintained by the presence server 320 in data store 326, as shown by table 350, can include an expertise element. Table 350 shows that each available live agent can be associated with one or more expertise type or category. For example, an expertise of one (“expertise=1”) can represent that an agent has expertise relating to product warranties; an expertise of two (“expertise=2”) can be associated with product technical problems; an expertise of three (“expertise=3”) can be associated with shipping; an expertise of four (“expertise=4”) can be associated with sales, and so forth. Each expertise category can have a corresponding watcher 330, 334, and 338, which monitors all live agents having that expertise. Filters 331, 335, and 339 can be used to order the live agents in a preferential manner, such as by least used agent first.

The contact center components 340 accept a call from a caller and prompt the caller for session specific information which is stored in data store 346. The prompting can indicate a live agent is needed, which causes agent transfer component 348 to invoke a get agent 342 function. The get agent 342 function uses listeners 344 linked to watchers 330, 334, and 338 to determine an available agent having the requisite expertise. Additional information, such as agent desktop (e.g., node 310) URL addresses (e.g., browser_id and phone_id from table 350) can also be acquired. The agent transfer component 348 can transfer the caller to the identified agent, who thereafter handles the caller's problem.

As used herein, the communication node 310 can be a node communicatively linked to presence server 320, which maintains presence information concerning the node 310. The communication node includes a presentity 312 and one or more PUA 314. The presentity 31.2 can provide presence information to a presence service. The presentity 312 can be used to model a presence being exposed and is independent of its manifestation, in any user interface. In practice, the presentity 312 typically is used to uniquely identify a person.

The PUA 314 can be a means for a principal to manipulate zero or more presentities 312, where a principal is a human, a program, or a collection of users or programs that choose to appear to a presence service (provided by the presence server 320) as a single unique actor distinct from other principals. Typically, the PUA 314 can be a computer, mobile telephone, SIP phone, two-way radio, personal data assistant or other computing device that is used by the presentity 312. That is, the presentity 312 can use the PUA 314, which publishes information to the presence server 320 and/or which registers with the presence server 320.

In one arrangement, the presence server 320 can act as either a presence agent 323 or a proxy 324. The presence server 320 can be part of a middleware solution. For example, the presence server can be a WEBSPHERE presence server.

Each watcher 330, 334, and/or 338 can request presence information about one or more presentity 312 or watcher 330, 334, 338. Special types of watchers 330, 334, 338 can include a fetcher, a poller, and a subscriber. It is possible for a watcher 330, 334, 338 to define which parts of presence information (managed by presence server 320) is received using a set of configurable rules or filters 331, 335, 339.

In one embodiment, the watchers 330, 334, 338 and filters 331, 335, 339 can be configured so that each watcher 330, 334, 338 corresponds to an expertise category. An expertise category being a particular type of skill which some contact center agents possess, which is used to respond to contact center requests.

Data stores 326 and 346 can be a physical or virtual storage space configured to store digital information. Data stores 326 and 346 can be physically implemented within any type of hardware including, but not limited to, a magnetic disk, an optical disk, a semiconductor memory, a digitally encoded plastic memory, a holographic memory, or any other recording medium. Each of the data stores 326 and 346 can be a stand-alone storage unit as well as a storage unit formed from a plurality of physical devices. Additionally, information can be stored within data stores 326 and 346 in a variety of manners. For example, information can be stored within a database structure or can be stored within one or more files of a tile storage system, where each file may or may not be indexed for information searching purposes. Further, data stores 326 and 346 can utilize one or more encryption mechanisms to protect stored information from unauthorized access.

The components of system 300 can be communicatively linked to each other via a network (not shown). The network can include any hardware/software/and firmware necessary to convey data encoded within carrier waves. Data can be contained within analog or digital signals and conveyed though data or voice channels. The network can include local components and data pathways necessary for communications to be exchanged among computing device components and between integrated device components and peripheral devices. The network can also include network equipment, such as routers, data lines, hubs, and intermediary servers which together form a data network, such as the Internet. The network can also include circuit-based communication components and mobile communication components, such as telephony switches, modems, cellular communication towers, and the like. The network can include Sine based and/or wireless communication pathways.

FIG. 4 is a schematic diagram of a standards based contact center 400 from an agent perspective that is implemented using WEBSPHERE enabled components and associated tooling in accordance with an embodiment of the inventive arrangements disclosed herein. Center 400 represents one particular embodiment for system 100, 200, and/or 300. It should be noted that center 400 utilizes WEBSPHERE enabled components for illustrative purposes only and the scope of the invention is not to be construed as limited in this regard. Other middleware solutions and open standards based solutions can be substituted and adapted to achieve approximately equivalent results.

An illustrative scenario for center 400 can show how the components interact. In this scenario, a call can come in over a telephone to the contact center 400 using a standard telephone, where the call is transferred to an agent connected to contact center components using agent desktop 410. The agent can utilize any personal computer in an operations center as the agent desktop 410 and is not trained to a particular station. The agent can also remotely (i.e., external to an operations center, such as through a home computer) connect to contact center components using a Web browser 412 and SIP based telephone 414. The agent can sign onto portal 424 via an agent desktop portlet 425. For example, the agent can enter a user id and password and hit a SUBMIT button.

The desktop agent portlet can call the WEBSPHERE PRESENCE SERVER (WPS) 426 with a publish/subscribe mechanism. Presence information can be conveyed from the agent desktop to a presence server 426 using a CPIM or CPP based XML document, which includes elements specific to contact centers, as illustrated in system 100. An IP address of the agent's SIP phone 414, browser 412, Blocks Extensible Exchange Protocol (BEEP) address, and other information including agent expertise and agent utilization can be conveyed to the presence server 426. After login onto the system, a default screen can be presented in the browser 412 that indicates that the agent is active and available.

It should be emphasized that use of a LOTUS Lightweight Messaging (LWM) client and the BEEP protocol is just one contemplated technique for communicating with the agent desktop and that the invention is not to be limited in this regard. That is, any of a variety of other techniques can be substituted that provide approximately equivalent function to LWM and BEEP. For example. Asynchronous JavaScript and XML (AJAX) based clients using HTTP can establish communications with the agent desktop in one contemplated embodiment.

Watchers 427 can be plugged into the presence server 426 for items of interest to the contact center. One item of interest can be agent expertise and there can be a one-to-one correspondence between watchers 427 and expertise. When the agent logs onto the contact center 400, he/she registers with the presence server 426. The presence server 426 can update watcher 427 information so that those watchers associated with expertise(s) of the logged in agent are informed that a new agent having this expertise is available for receiving calls.

At this time, a call between a caller on a phone and the contact center 400 can be active. In a running Voice XML (VXML) application, the WEBSPHERE Voice Enabler (VE) can prompt a user for input. The VE can interact with the WEBSPHERE VOICE SERVER to determine user context information and a purpose of a call. The purpose of the call can be associated with an expertise category. The caller responses can indicate that agent assistance is needed. For example, a caller can select a dialog option to speak with a live agent.

The VXML application can transfer the caller to an agent transfer servlet co-located with the SIP proxy 416. For example, the get agent 428 function can be executed for a particular expertise, such as “expertise=1”. A watcher 427 associated with expertise=1 can be contacted. A further filter (i.e., a load balancing filter) can be applied to the watcher 427 that filters based on a usage criteria. For example, the least used agent can be granted priority by the load balancing filter. Other load balancing filters can be used and the invention is not to be construed as limited in this regard.

For instance, filters for selecting an agent having the needed expertise can utilize criteria of any complexity. Filtering criteria can include, but is not limited to, a length of time of an agent in a watcher list, a category of watcher (i.e., dedicated agent or independent knowledge broker), a customer satisfaction rating for interactions with tire agent, a skill level in the expertise category of the agent, an estimated wait time for an agent based upon a current queue, and the like. Accordingly, contact centers can customize agent selection in numerous business specific manners to improve customer satisfaction, to decrease costs to a business, to minimize wait time, and/or to achieve other business objectives.

Once the transfer is made, the agent can receive the call using the SIP phone 414 and can receive caller specific data via the browser 412. The communication can include the SIP proxy 416 and/or a real time protocol (RIP) connection direct to the caller 417.

It should be noted that middleware programming interface of contact center 400 allows for custom services to be created for contact center operations. These services can be provided by the middleware provider and/or by third party providers, which include traditional vendors of contact center solutions. The presence server 426 subscription function permits the dynamic registration of agents and agent capabilities. Further, the rich presence function of the server 426 can permit real-time status metrics on agent operations. Generally, contact center 400 encourages the interoperation of services provided by different sources, which permits the contact center 400 to gracefully evolve and to use best practices and applications tailored to the specific needs of the business or organization for which the contact center 400 is implemented.

Further, the arrangements of contact center 400 permit knowledge brokering and independent agent services to be provided to a multitude of business entities. That is, agents can operate as independent knowledge brokers, who sell their knowledge and services in a manner analogous to how goods/merchandise are sold today. Thus, contact center 400 can connect people with knowledge to sell, such as doctors, lawyers, and other professionals, to those willing to pay for this knowledge (i.e., callers or communicators contacting the call center). Businesses can utilize these independent contractors to handle difficult problems that dedicated staff is unable to handle, to handle overflow to ensure that queue waif times remain under a configurable duration, and to offer an unprecedented level of contact center flexibility. The open standards based nature of center 400 permits the seamless integration of independent knowledge brokers and dedicated personnel in a fashion: transparent to callers. In short, higher quality contact center services can be provided at less costs using center 400 than is possible using conventionally implemented contact centers.

The present invention may be realized in hardware, software, or a combination of hardware and software. The present invention may be realized in a centralized fashion in one computer system or in a distributed fashion where different elements are spread across several interconnected computer systems. Any kind of computer system or other apparatus adapted for carrying out the methods described herein is suited. A typical combination of hardware and software may be a general purpose computer system with a computer program that, when being loaded and executed, controls the computer system such that it carries out the methods described herein.

The present invention also may be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or alter either or both of the following: a) conversion to another language, code or notation; b) reproduction in a different material form.

This invention may be embodied in other forms without departing from the spirit or essential attributes thereof. Accordingly, reference should be made to the following claims, rather than to the foregoing specification, as indicating the scope of the invention.

What is claimed is:

1. A presence document comprising:
a plurality of contact center elements configured to permit a contact center to exchange presence information with a Common Profiles for Presence (CPP) compliant presence server, wherein the presence server is used to determine contact center agent availability, wherein one of the contact center elements is an expertise element, which indicates a type of expertise of a contact center agent that is needed for handling customer requests, wherein the presence document is an Extensible Markup Language (XML) based document that conforms to an Internet Engineering Task Force (IETF) established standard.

2. The presence document of claim 1, wherein said presence document is configured to be conveyed across Common Profiles for Presence (CPP) compliant protocol boundaries without modification.

3. The presence document of claim 1, wherein the plurality of contact center elements are an extension of a Rich Presence Information Data (RPID) format.

4. The presence document of claim 1, wherein the plurality of contact center elements comprise at least one element selected from a group of elements consisting of an agent status, an agent level, a utilization rate, an average call time duration, and/or an average number of calls per day.

5. The presence document of claim 1, wherein the plurality of contact center elements comprise at least two elements selected from a group of elements consisting of an agent status, an agent level, a utilization rate, an average call time duration, and/or an average number of calls per day.

6. The presence document of claim 1, wherein the plurality of contact center elements comprise at least four elements selected from a group of elements consisting of an agent status, an agent level, a utilization rate, an average call time duration, and/or an average number of calls per day.

7. The presence document of claim 1, wherein the plurality of contact center elements comprise an agent status and an agent level, wherein the agent status indicates whether a contact center agent is busy, available, on break, and out of office, and wherein the agent level indicates a degree of authority of an associated contact center agent.

8. The presence document of claim 1, wherein a plurality of watchers are used in conjunction with the presence server, wherein each of the watchers corresponds to a particular expertise, wherein each watcher subscribes to presence information managed by a presence server, whereby each watcher watches the expertise across all contact agents having presence information managed by the presence server.

9. A presence management system for a contact center comprising;
a presence server configured to accept, manage, and distribute presence information, wherein the presence information is conveyed to and from the presence server utilizing Extensible Markup Language (XML) based documents that conforms to an Internet Engineering Task force (IETF) established standard, wherein the XML based documents are configured to be conveyed across Common Profiles for Presence (CPP) compliant protocol boundaries without modification, wherein the XML based documents each include a plurality of contact center elements;
a data store communicatively linked to the presence server, wherein the data store is configured to store the presence information, said stored presence information including presence information for a plurality of contact center agents; and
a plurality of watchers configured to subscribe to the presence information managed by the presence server.

10. The system of claim 9, wherein one of the contact center elements is an expertise element, which indicates a type of expertise of a contact center agent that is needed for handling customer requests.

11. The presence document of claim 10, wherein the plurality of contact center elements comprise art agent status and an agent level, wherein the agent status indicates whether a contact center agent is busy, available, on break, and out of office, and wherein the agent level indicates a degree of authority of an associated contact center agent.

12. The system of claim 10, wherein each of the watchers corresponds to a unique expertise and wherein that watcher is associated with the presence information for all of the contact center agents having the unique expertise to which that watcher corresponds.

13. The system of claim 12, wherein a one-to-one correspondence exists between watchers and unique expertise values.

14. The system of claim 9, wherein the plurality of contact center elements are an extension of a Rich Presence information Data (RPID) format.

15. The presence document of claim 9, wherein the plurality of contact center elements comprise at least two element selected from a group of elements consisting of an agent status, an expertise, an agent level, a utilization rate, an average call time duration, and/or an average number of calls per day.

16. The presence document of claim 9, wherein the plurality of contact center elements comprise at least three elements selected from a group of elements consisting of an agent status, an agent level, a utilization rate, an average call time duration, and/or an average number of calls per day.

17. The presence document of claim 9, wherein the plurality of contact center elements comprise at least four elements selected from a group of elements consisting of an agent status, an agent level, a utilization rate, an average call time duration, and/or an average number of calls per day.

18. The presence document of claim 9, wherein the plurality of contact center elements comprise at least five elements selected from a group of elements consisting of an agent status, an agent level, a utilization rate, an average call time duration, and/or an average number of calls per day.

19. A method for conveying presence information comprising:
a plurality of presence user agents (PUAs) conveying an XML based presence document to a presence server;
a plurality of watchers associated with a computing system subscribing to the presence server;
conveying an XML based presence document to the watchers;
the watchers extracting information from the XML based presence document;
the watchers sending the extracted information to the computing system; and
said computing system performing at least one programmatic action responsive to receiving the extracted information, wherein each of the XML based presence documents conform to a Common Profiles for Presence (CPP) standard and includes a plurality of system specific elements and related values, wherein one of the system specific elements is a focus element, wherein each of the watchers corresponds to a particular value of the focus element, and wherein each of said watchers watches said plurality of presence user agents (PUAs).

20. The method of claim 19, wherein said computing system is a contact center, wherein each of the presence user agents corresponds to a contact center agent, wherein said focus element is an expertise element that indicates a type of expertise of an associated contact center agent that is used in handling customer requests, whereby each watcher watches the expertise element across all the contact agents.
